(19) United States
(12) Patent Application Publication
(10) Pub. No.: US 2003/0198788 A1
(43) Pub. Date: Oct. 23, 2003

(54) Method and device for producing a multi-ply web of flexible material, such as paper and nonwoven, and multi-ply material produced by the method

(76) Inventors: Anders Andersson, Stenungsund (SE); Eva-Li Saarvali, Vastra Frolunda (SE)

Correspondence Address: YOUNG & THOMPSON, 745 SOUTH 23RD STREET 2ND FLOOR, ARLINGTON, VA, 22202

(21) Appl. No.: 10/373,087

(22) Filed: Feb. 26, 2003

Related U.S. Application Data
(60) Provisional application No. 60/359,339, filed on Feb. 26, 2002.

(51) Int. Cl. B32B 7/14

(52) U.S. Cl. 428/195.1; 156/291

(57) ABSTRACT

Method for producing a multi-ply web of flexible material by gluing the plies. Glue is transferred in subsequent steps to a first web shaped flexible material via at least two patterned glue transfer rolls, in a pattern corresponding to the pattern of the glue transfer rolls. A second web shaped material is brought in contact with the glue bearing side of the first web shaped material in at least one press nip between at least one patterned lamination roll and an impression roll. The at least one lamination roll has a three-dimensional pattern having a shape and configuration so as to apply pressure to the combined first and second web shaped materials substantially only just opposite at least some of the glue bearing areas of the first web shaped material, and is driven in registry with the first and/or second glue transfer roll.

### FIELD OF THE INVENTION

The present invention refers to a method for producing a multi-ply web of flexible material, such as paper and nonwoven material, by means of gluing the plies. Especially it refers to production of tissue products such as toilet and kitchen paper, paper towels, handkerchiefs, wiping material and the like. The invention further refers to a multi-ply web of flexible material, such as paper and nonwoven, comprising at least a first and a second ply, which are interconnected by means of gluing in a glue pattern. The invention also refers to a product made from the multi-ply web.

### BACKGROUND OF THE INVENTION

It is very common to laminate two or more tissue plies in order to produce the final tissue product. Herewith a more flexible and softer tissue product is obtained as compared to if one single ply with a corresponding thickness and basis weight had been produced as for the laminated product. The absorbent capacity and the bulk are moreover improved.

The lamination of two or more tissue plies is often made by means of gluing. A mechanical embossing of the plies is also often performed before they are glued together. It is further known to laminate two plies only by means of a mechanical embossing, at which a mechanical joining of the plies occurs in the embossing sites.

Through for example EP-A-796 727 it is known to first emboss two paper plies in a three dimensional structure with alternating raised and recessed portions, after which glue is applied to one of the plies and the two plies are joined in a press nip between two embossing rolls, so that the raised portions of the respective plies are glued to each other. A similar embossing procedure is shown in EP-A-738 588, according to which the glue also has a colouring effect.

In WO 95/08671 there is enclosed an example of so called nested embossing, in which the two individually embossed plies are combined and joined with the raised portions of one ply nesting into the recessed portions of the opposite ply.

Through U.S. Pat. No. 5,443,889 there is known a procedure for laminating two paper plies, which are fed over a pattern roll each, said pattern rolls having alternating raised and recessed portions and where glue is applied to one ply while this is led over the roll. The two paper plies are then glued together in a nip between the two pattern rolls, which are in register with each other so that a joining and compression of the paper plies occurs in a pattern corresponding to the raised portions of the pattern rolls.

A drawback that occur in connection with embossing a paper web where this is compressed in spots, is that a considerable strength reduction occurs in the embossing sites, which effects the strength properties of the entire paper product. Strength reductions of up to 70% of an embossed paper as compared to a corresponding non-embossed paper are not unusual.

U.S. Pat. No. 3,672,950 discloses a method for producing a quilted or cushioned adhesively laminated tissue product in which glue is applied in a certain pattern to one tissue ply in a press nip between a first pattern roll and an impression roll. This ply is laminated to another ply in a press nip between the same impression roll and a second pattern roll having a pattern corresponding with that of the first pattern roll. The first and second pattern rolls are driven in registry so that pressure is applied substantially only to the adhesive-bearing regions of the plies. The two plies are in different conditions of stress during the lamination process, so that a quilted or cushioned product is provided.

### OBJECT AND SUMMARY OF THE INVENTION

The object of the present invention is to provide a method for producing a multi-ply web of flexible material, such as paper and nonwoven, and combinations thereof, wherein at least two plies of flexible material are laminated together by gluing. The lamination should be lenient to the material so that its strength properties are substantially maintained. The absorbent capacity and bulk of the finished product should moreover be high. The method should provide a freedom to use different glue patterns for strength and/or aesthetical reasons.

According to the invention the method comprises: transferring glue in subsequent steps to a first web shaped flexible material by means of at least two glue transfer rolls each having a three dimensional pattern of alternating raised and recessed portions in first and second press nips respectively, in a pattern corresponding to the shape and configuration of said raised portions;

bringing a second web shaped flexible material in contact with the glue bearing side of said first web shaped flexible material in at least one further press nip between at least one patterned lamination roll and an impression roll, said at least one patterned lamination roll having a three-dimensional pattern of alternating raised and recessed portions having a shape and configuration so as to apply pressure to the combined first and second web shaped materials substantially only just opposite at least some of the glue bearing areas of the first web shaped material, wherein the at least one patterned lamination roll is driven in registry with the first and/or second glue transfer roll.

It is preferred that the three-dimensional pattern of the first patterned glue transfer roll is different from that of the second patterned glue transfer roll.

In one embodiment at least two patterned lamination rolls are provided, wherein the first lamination roll has a three-dimensional pattern of alternating raised and recessed portions having a shape and configuration corresponding to the pattern of one of said glue transfer rolls, and the second lamination roll has a three-dimensional pattern of alternating raised and recessed portions having a shape and configuration corresponding to the pattern of another of said glue transfer rolls.

In an alternative embodiment one patterned lamination roll is provided having a three-dimensional pattern of alternating raised and recessed portions having a shape and configuration corresponding to the patterns of both the first and second glue transfer rolls.

In one aspect of the invention coloured glue is applied to the first web shaped material by at least one of the patterned glue transfer rolls. Glues of different colour or tint may, in a further aspect of the invention, be applied by the first and second patterned glue transfer rolls respectively.

According to one embodiment at least one of the web shaped materials is before lamination with the opposite web shaped material exerted to a three dimensional patterning provided on the web shaped material while being formed wet, during drying of the wet material and/or in a dry state.

According to a further embodiment at least two plies before lamination is exerted to a three dimensional patterning, the patterns provided on the at least two plies having different structures, for example one pattern being relatively fine and another pattern being relatively coarse.

According to still a further embodiment at least one ply is reinforced with strings of glue or curing bonding agent, for example latex. The curing agent is cured after lamination.

The patterns of the glue transfer rolls are chosen so that glue is applied to said first ply in an amount corresponding to between 0.03 and 9%, preferably between 0.1 and 6% of the total surface area of the respective ply.

The invention further refers to a multi-ply web of flexible material, such a paper and nonwoven, comprising at least one first and one second ply which are interconnected by gluing in glue sites forming a glue pattern wherein the plies are glued together by at least two glue patterns which are different as to shape and/or colour.

The size of each glue site amounts to between 0.15 and 150 mm², preferably between 0.5 and 100mm² and more preferably between 1 and 15 mm².

In an alternative embodiment the size of each glue site amounts to between 150 and 400 mm².

It is preferred that the glue sites take up a total area of between 0.03 and 9%, preferably between 0.1 and 6% of the total surface area of the respective ply.

In one aspect of the invention the glue in at least some of the glue sites is coloured. There may further be provided glue sites of different colour or tint.

In a further aspect of the invention at least one of the plies has a three-dimensional pattern provided before joining with the opposite ply.

By using the method of the invention there will be no real embossing of the material web in connection with the lamination, but only a gluing together of the plies in spots. Herewith a strength reduction of the final product is avoided at the same time as void volumes are created between the plies between the glue sites, which increase the bulk and absorption capacity. The bulk of the individual plies is also substantially maintained throughout the lamination process. Different glue patterns may be used for the different pattern rolls in order to provide desired bonding strength and aesthetical appearance. Coloured glue may be used in at least one of the patterned glue transfer rolls.

The term spots, in this respect, refers to any shape of the glue sites, such as small points, lines or any desired geometrical shape.

Further features of the invention are disclosed in the following description and in the claims.

### BRIEF DESCRIPTION OF THE DRAWINGS

The invention will in the following be closer described with reference to a couple of embodiments shown in the accompanying drawings.

FIG. 1 shows a schematic side view of a device for performing the method according to one embodiment of the invention.

FIG. 2 shows a schematic side view of a device according to an alternative embodiment.

FIG. 3 is a schematic cross section of a two-ply paper produced according to the method.

FIG. 4a is a plan view of a glue pattern provided by the method according to the invention.

FIG. 4b is a plan view of the combined patterns of the lamination rolls, which may be used for the glue pattern illustrated in FIG. 4a.

FIG. 4c shows the combinations of the patterns according to FIG. 4a and 4b.

FIG. 5 is a schematic cross section of an embodiment of a three-ply paper according to the invention.

### DETAILED DESCRIPTION OF THE INVENTION

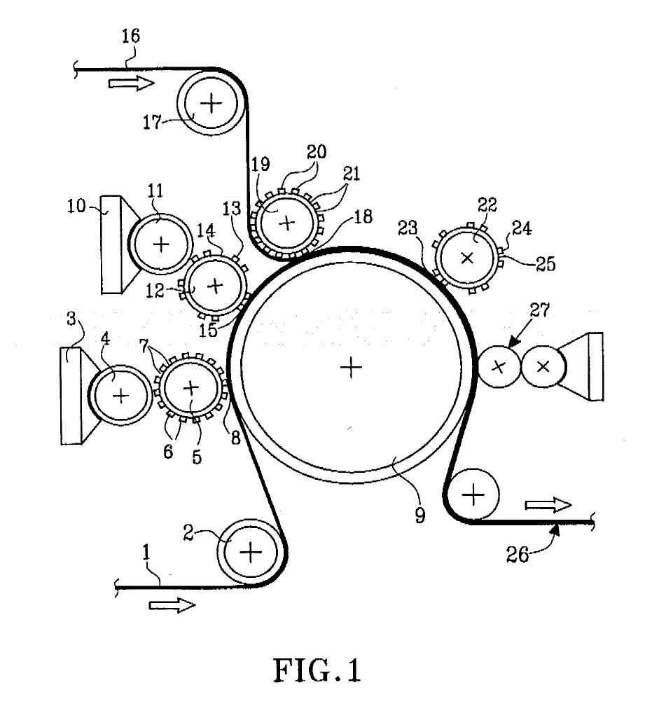

FIG. 1 shows a device for producing a two-ply material, e.g. paper, especially tissue paper. A first paper web 1 is fed over a roll 2 towards a first glue application station. This comprises a first glue chamber 3 from which glue is applied on a first glue roll 4. The first glue roll 4 is in contact with a first patterned glue transfer roll 5, which along its periphery is provided with a pattern of alternating raised 6 and recessed portions 7. The first glue roll 4 is only contacting the tops of the raised portions 6, so that glue is only applied thereon. The paper web 1 is passed into a press nip 8 between the first patterned glue transfer roll 5 and a centrally placed impression roll 9. Glue will thus be applied to the first paper web 1 in a pattern corresponding to the configuration of the tops of the raised portions 6. The pressure in the press nip between the first patterned glue transfer roll 5 and the impression roll 9 is only sufficiently high to accomplish a transfer of glue to the paper web 1. However there should preferably be no deformation of the paper web, i.e. no impression of the raised portions 6 of the first patterned glue transfer roll 5 into the paper web.

A second glue application station is further provided. This comprises a second glue chamber 10 from which glue is applied on a second glue roll 11. The second glue roll 11 is in contact with a second patterned glue transfer roll 12, which along its periphery is provided with a pattern of alternating raised 13 and recessed portions 14. Said pattern is preferably different from that of the first patterned glue transfer roll 5. The second glue roll 11 is only contacting the tops of the raised portions 13, so that glue is only applied thereon. The paper web 1 is passed into a second press nip 15 between the second patterned glue transfer roll 12 and the centrally placed impression roll 9. Glue will thus be applied to the first paper web 1 in a pattern corresponding to the configuration of the tops of the raised portions 13. The pressure in the press nip between the second patterned glue transfer roll 12 and the impression roll 9 is only sufficiently high to accomplish a transfer of glue to the paper web 1. However there should preferably be no deformation of the paper web, i e no or only slight impression of the raised portions 6 of the second patterned glue transfer roll 12 into the paper web.

A second paper web 16 is fed over a roll 17 and into a third press nip 18 between a first patterned lamination roll 19 and the centrally placed impression roll 9. The first patterned lamination roll 19 has a three dimensional pattern of raised 20 and recessed portions 21 corresponding to the pattern of the first patterned glue transfer roll 5. The term “corresponding to” in this respect means that the raised portions 20 either have the same shape and size of the effective surface area as the raised portions 6 of the first pattern roll 5, the same shape but a larger effective surface area than the raised portions 6 of the first glue transfer roll 5 so as to extend outside the outer circumference of the glue sites provided by the first glue transfer roll 5 or a different shape and a larger effective surface area than the raised portions 6 of the first glue transfer roll 5. For example a glue pattern provided by the first transfer roll 5 may be in the form of groups of three dots arranged in a triangular configuration, wherein the raised portions 20 of the first lamination roll 19 may either be exactly the same as or slightly larger than the glue pattern, or may for example be in the form of a triangle covering the three dots. In all these cases the relative position of the pattern on the two pattern rolls 5 and 19 are in correspondence with each other.

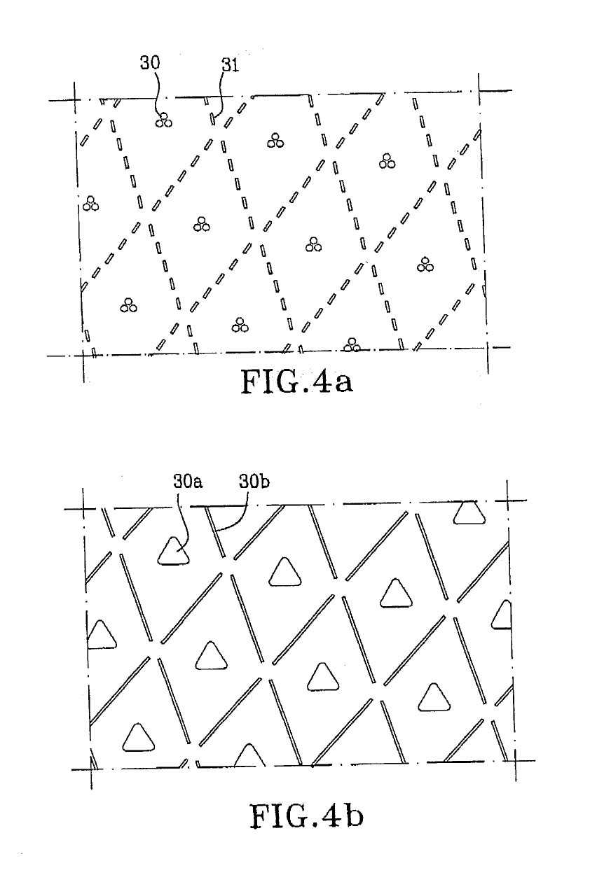

This is illustrated in FIG. 4a and b, in which FIG. 4a shows two glue patterns, one in the form of three dots arranged in a triangular configuration 30 and the other in the form of dots forming a checked patten 31. FIG. 4b shows an example of patterns 30a and 30b that may be used on the lamination rolls, said patterns corresponding to and covering the glue patterns. FIG. 4c shows the glue patterns 30, 31 and lamination patterns 30a, 30b in superposed position.

A second lamination station is further provided comprising a fourth press nip 23 between a second patterned lamination roll 22 and the centrally placed impression roll 9. The second patterned lamination roll 22 has a three dimensional pattern of raised 24 and recessed portions 25 corresponding to the pattern of the second patterned glue transfer roll 12. This means that the two patterns either are identical as to size and shape or that the pattern of the second lamination roll 22 is slightly larger than and thus covers a somewhat larger area than the pattern of the second glue transfer roll 12, in the same way as explained above. The second patterned glue transfer roll 12 and the second patterned lamination roll 22 are driven in registry with each other so that the first and second paper webs 1 and 16 are pressed and glued together in a pattern corresponding to the configuration of the tops of the raised portions 24 of the second patterned lamination roll 22.

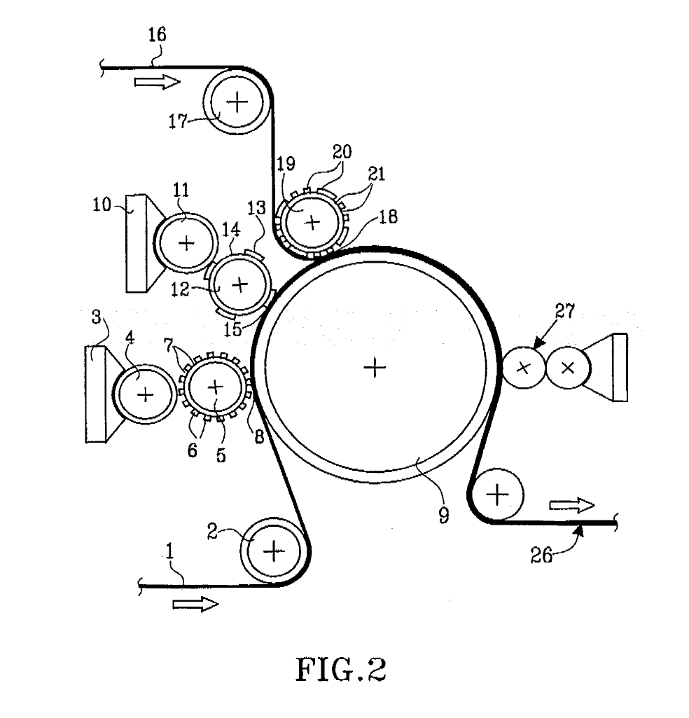

In the alternative embodiment, shown in FIG. 2, only one lamination roll is provided, which has a three-dimensional pattern of alternating raised 20 and recessed portions 21 having a shape and configuration corresponding to the patterns of both the first and second glue transfer rolls 5 and 12. This lamination roll is driven in registry with both the first and second glue transfer rolls 5 and 12.

The pattern on the two glue transfer rolls 5 and 12 can be optional, but should be chosen so that glue is applied to the paper web 1 in an amount corresponding to between 0.03 and 9%, preferably between 0.1 and 6% the total surface area of the paper web 1. In the present case the glue sites are sparsely distributed over substantially the entire area of the laminated product. It is with the method according to the invention possible to provide a very distinct positioning of the glue sites, wherein a very small amount of glue is needed. This means advantages with respect to softness, drapability, absorption etc.

In the case that the glue pattern comprises a plurality of discrete glue sites the number of glue sites per area unit should amount to between 25 and 350,000 glue sites per m², preferably between 300 and 180,000 glue sites per m² and more preferably between 800 and 50,000 glue sites per m². According to one embodiment the size of each glue site should amount to between 0.15 and 150 mm², preferably between 0.5 and 100 mm² and more preferably between 1 and 15 mm². According to an alternative embodiment the size of each glue site amounts to between 150 and 400 mm, which applies for certain composite glue patterns comprising thin lines, e.g. 1 mm in width, forming for example a symbol or a figurative pattern. In such an embodiment the number of glue sites per m² will be in the lower part of the above interval, for example less than 800.

In the case of large glue sites screened patterns can be used, which means that each glue pattern unit is built up of a plurality of small screen dots. The size of the glue site in this case is defined as the circumscribed area of the combination of screen dots forming a glue pattern unit.

According to a further embodiment the glue pattern is composed of continuous lines forming for example a network.

Preferred glues are the ones commonly used for paper, such as carboxy methyl cellulose (CMC), polyvinyl alcohol (PVOH), ethylene vinyl acetate (EVA), polyvinyl acetate (PVAc), ethylene acrylic acid, vinyl acetate acrylic acid, styrene acrylic acid, polyurethane, polyvinylidene chloride, starch, chemically modified starch, dextrin, water soluble polymers such as latexes and milky colloids in which natural or synthetic rubber or plastic is suspended un water. In case the material webs are of other material than paper, glues suited for these materials are of course chosen.

It is preferred to use glues having a relatively high dry content, since this enables a distinct positioning of the glue sites.

It is understood that three or more glue application and lamination stations may also be provided.

Coloured glues may also be used, which gives a shading effect and therewith a patterning effect to the material. In one preferred embodiment of the invention one of the glue patterns is chosen so as to provide a desired bonding strength and adhesion between the plies, while the other glue pattern is chosen to provide an aesthetical effect. The first glue may be colourless while the second glue is coloured. Glue with different colours may also be used for the different patterns. Both patterns may of course be chosen to provide an aesthetical appearance. Any optional patterns may be used, such as dot patterns, straight or curved lines, geometrical figures, fantasy figures, logotypes, text, letters etc. The glue sites may also be in the form of continuous lines for example forming a network pattern. In FIG. 4 a dot pattern is indicated with the numeral 30 and a figurative pattern is indicated with the numeral 31.

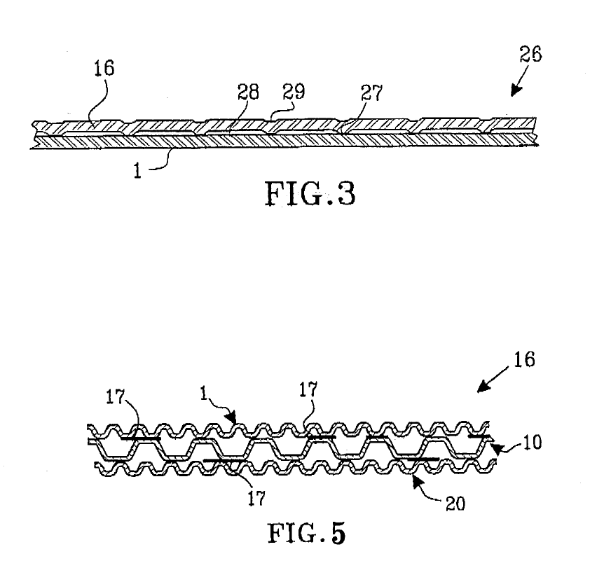

In FIG. 3 there is shown an example of a two-ply paper 26 produced according to the invention, at which the glue sites between the two paper plies 1 and 16 are denoted 27. Between the glue sites 27 the paper plies 1 and 16 are free and separated from each other and empty spaces 28 are created which increase the bulk and absorption capacity of the material, properties that are important for e.g. soft absorbent paper. The second paper web 16 can have just opposite the glue sites slight compacting impressions 29 caused by the laminating patterned rolls 19 and 22. The impressions 29 shown in the drawings are also a result of that the ply 16 between the glue sites 27 will bulge slightly from the first ply 1.

One or both of the patterned glue transfer rolls 5 and 12 as well as one or both of the patterned lamination rolls 19 and 22 may be supported in such a way that they can easily be swung out of and into operative position. The patterned surface on the rolls 5, 12, 19, 22 may preferably be provided in the form of exchangeable sleeves, which involves a quick possibility of changing pattern.

Also in these third and fourth press nips the pressure should be low but sufficiently high to provide a gluing together of the two paper webs 1 and 10. There is preferably provided only a slight impression of the pattern of the pattern roll 12 in the second paper web 10. It is further noted that the impressions are only in the second web 10 while the first web 1 remains substantially smooth. The laminated two-ply product is denoted 26.

The web tension of said first and second plies 1 and 16 are preferably substantially equal as they are fed into the second press nip 12. Herewith there will be no foreshortening effect from the lamination.

In an alternative embodiment of the invention only one lamination roll 19 is provided, which has a pattern corresponding to one of the first or second glue transfer rolls 5 or 12, while pressure is not applied by any lamination roll to the glue pattern provided by the other of said first or second glue transfer rolls 5 or 12. For example in the case of one strength-providing glue pattern and one aesthetical glue pattern, which may be of a coloured glue, pressure may be applied only to the strength-providing glue pattern.

It is understood that the first and/or second paper webs 1 and 16 may each comprise two or more plies, so that a laminated product 26 with three or more plies is formed. In the case of laminating three or more plies more glue and/or a higher pressure in the lamination step may be needed as compared to when laminating only two plies.

It is further understood that additional patterned glue transfer rolls and lamination rolls may be used, in which case three or more plies can be laminated together.

A printing unit 33 may be arranged after the second lamination station for printing a pattern onto one side of the laminated product 26.

The paper webs 1 and 16 that are laminated can either be flat but also have a three-dimensional structure provided earlier in the process, for example during forming, dewatering and/or drying of the paper web. A three-dimensional structure may also be provided, by embossing the dry paper webs before lamination. The method according to the invention is very lenient to such a pattern, so that this is maintained substantially intact during the laminating process. Other important advantages of the invention are that the paper substantially maintains its strength properties through the process, which in many other lamination processes in which an embossing and deformation of the paper webs occur in connection with lamination, are lost.

In the case of a relatively flat structure of the laminated multiply product this can be converted into dense rolls or folded products, which means space- and cost saving.

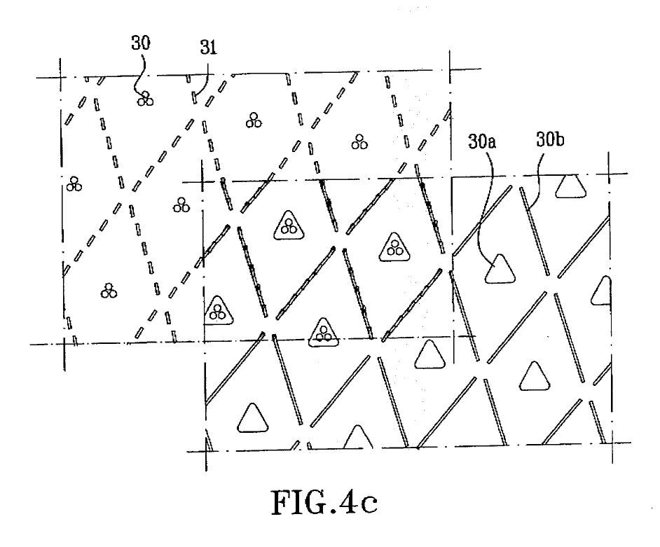

FIG. 5 shows an embodiment of a three-ply paper in which the plies 1, 16 and 32 before lamination have been exerted to a three dimensional patterning, for example embossing. The structures of the embossing patterns are different, so that the pattern structure of the middle ply 16 is coarser than that of the two outer plies 1 and 32. A high-bulk product is then obtained. The glue sites 27 between plies 1 and 16 may, as disclosed, be applied offset with respect to the glue sites between plies 16 and 32, or be applied just opposite each other. Other combinations of different embossing patterns may of course be used than what is shown in FIG. 5. Multi-ply products having different structures on opposite sides may be created if the two outer plies have different embossing structures, such as one coarser side and one smoother side. So called micro quilted embossing patterns may also be used. One or more plies may further be unembossed. In the case of a two-ply product a two-sided product is obtained if one ply is embossed and the other unembossed or have a different embossing structure.

The embossing patterns used for the different layers may also be the same. In this case the plies may be embossed jointly and then separated from each other before being, laminated by the method according to the invention. They may also be separately embossed before lamination.

The laminated multiply product may also if desired, due to the strong ply bonding provided by the glue spots, be embossed after the lamination process, thereby creating a softer material. The effective ply bonding is achieved due to the distinct gluing effect provided by the lamination rolls driven in registry with the glue transfer rolls. This ply bonding effect is not reduced when converting, for example rolling, the paper product, which may be the case for ply bonding provided by embossing.

At least one paper ply may further be reinforced with thin strings of glue or a curing bonding agent, such as latex. The glue strings may be effected for example by spray guns or via a roller. The reinforcement may for example take place on the outside of the laminated product after lamination and in register with the lamination process. The reinforcement may alternatively take place on the inside before or during the lamination, preferably in register. In the case of a curing bonding agent the paper product is cured after lamination, for example by heat treatment. When reinforcing the paper plies in this manner, very thin materials may be used, which otherwise would not have been possible to use, because of an insufficient strength to be handled in the converting process or in a dispenser.

The multi-ply web may be converted to any desired product, such as rolls, folded hand towels, wipes, handkerchief, napkins etc. It would be of advantage to use the multi-ply web according to the invention in so called center-feed coreless rolls, in which the paper is taken from the center of the roll. For a conventional multi-ply web in which joining of the plies is connected with embossing, the innermost revolutions, which are compressed rather hard so that the embossing is more or less destroyed, will not come out as a satisfactory product. In the multi-ply web according to the invention, on the other hand, lamination of the plies is separated from any patterning effect provided by embossing or the like and thus also the innermost revolutions of the coreless roll will form a useful product.

1. Method for producing a multi-ply web of flexible material, having a plurality of plies by gluing the plies, which comprises:
transferring glue in subsequent steps to a first web shaped flexible material via at least two glue transfer rolls each having a three dimensional pattern of alternating raised and recessed portions in first and second press nips respectively, in a pattern corresponding to the shape and configuration of said raised portions;
bringing a second web shaped flexible material in contact with the glue bearing side of said first web shaped flexible material in at least one further press nip between at least one patterned lamination roll and an impression roll, said at least one patterned lamination roll having a three-dimensional pattern of alternating raised and recessed portions having a shape and configuration so as to apply pressure to the combined first and second web shaped materials substantially only just opposite at least some of the glue bearing areas of the first web shaped material, wherein the at least one patterned lamination roll is driven in registry with at least one of the first and second glue transfer rolls.

2. Method as claimed in claim 1, wherein the three-dimensional pattern of the first patterned glue transfer roll is different from that of the second patterned glue transfer roll.

3. Method as claimed in claim 1, wherein at least two patterned lamination rolls are provided, a first lamination roll having a three-dimensional pattern of alternating raised and recessed portions having a shape and configuration corresponding to the pattern of one of said glue transfer rolls, and a second lamination roll having a three-dimensional pattern of alternating raised and recessed portions having a shape and configuration corresponding to the pattern of another of said glue transfer rolls.

4. Method as claimed in claim 1, wherein one patterned lamination roll is provided with a three-dimensional pattern of alternating raised and recessed portions having a shape and configuration corresponding to the patterns of both the first and second glue transfer rolls.

5. Method as claimed in claim 1, wherein one patterned lamination roll is provided with a three-dimensional pattern of alternating raised and recessed portions having a shape and configuration corresponding to the pattern of one of said glue transfer rolls, while pressure is not applied to the combined first and second web shaped materials opposite the glue bearing areas applied by another of said glue transfer rolls.

6. Method as claimed in claim 1, wherein coloured glue is applied to the first web shaped material by at least one of the patterned glue transfer rolls.

7. Method as claimed in claim 1, wherein glues of different colour or tint are applied by the first and second glue transfer rolls respectively.

8. Method as claimed in claim 1, wherein at least one of the web shaped materials before lamination with the opposite web shaped material is exerted to a three dimensional patterning provided on the web shaped material while wet, during drying of the wet material or in a dry state.

9. Method as claimed in claim 8, wherein at least two plies before lamination is exerted to a three dimensional patterning, the patterns provided on said at least two plies having different structures, one pattern being relatively fine and another pattern being relatively coarse.

10. Method as claimed in claim 1, further comprising reinforcing at least one ply with strings of glue or curing bonding agent.

11. Method as claimed in claim 10, further comprising curing said bonding agent after lamination.

12. Method as claimed in claim 1, wherein the patterns of the glue transfer rolls are chosen so that glue is applied to said first web shaped material in an amount corresponding between 0.03 and 9% of the total surface area of the first web shaped material.

13. Multi-ply web of flexible material, comprising at least one first and one second ply which are interconnected by gluing in glue sites forming a glue pattern, wherein the plies are glued together by at least two glue patterns which are different as to at least one of shape and colour.

14. Multi-ply web as claimed in claim 13, wherein the size of each glue site amounts to between 0.15 and 150 mm².

15. Multi-ply web as claimed in claim 13, wherein the size of each glue site amounts to between 150 and 400 mm².

16. Multi-ply web as claimed in claim 13, wherein the glue sites take up a total area of between 0.03 and 9% of the total surface area of the respective ply.

17. Multi-ply web as claimed in claim 13, wherein the glue in at least some of the glue sites is coloured.

18. Multi-ply web as claimed in claim 17, wherein glue sites of different colour or tint are provided.

19. Multi-ply web as claimed in claim 13, wherein at least one of the plies has a three-dimensional pattern provided before joining with the opposite ply.

20. Multi-ply web as claimed in claim 19, wherein at least two plies have a three-dimensional pattern provided before joining with the opposite ply, the patterns provided on said at least two plies having different structures, one pattern being relatively fine and another pattern being relatively coarse.

21. Multi-ply web as claimed in claim 17, wherein the multi-ply web has one external side with a relatively coarse three-dimensional structure and one external side with a relatively smooth structure.

22. Multi-ply web as claimed in claim 20, wherein the multi-ply web has at least three plies, with one middle ply having a relatively coarse three-dimensional structure.

23. Multi-ply web as claimed in claim 13, wherein at least one ply is reinforced with strings of glue or curing bonding agent.

24. Multi-ply web as claimed in claim 13, wherein at least one of the plies has holes therein.

25. A roll, folded towel, wipe, handkerchief, napkin and the like of web-shaped material, wherein said web-shaped material is a multi-ply web as claimed in claim 13.

26. A roll of web-shaped material as claimed in claim 25, wherein said roll is a center-feed coreless roll.

27. A product of web-shaped material as claimed in claim 25, wherein said web-shaped material is tissue paper.
